(19) United States
(12) Patent Application Publication
(10) Pub. No.: US 2018/0121846 A1
(43) Pub. Date: May 3, 2018

(54) SYSTEM AND METHOD FOR DETERMINING MODERATE CUSTOMER DISSATISFACTION

(71) Applicant: Interactive Intelligence Group, Inc., Indianapolis, IN (US)

(72) Inventor: Aaron I. Bickell, Durham, NC (US)

(21) Appl. No.: 15/342,882

(22) Filed: Nov. 3, 2016

(51) Int. Cl. G06Q 10/06; G06Q 30/00

(52) U.S. Cl. CPC G06Q 10/0635; G06Q 30/01

(57) ABSTRACT

A system and method are presented for determining moderate customer dissatisfaction in an external contact and organization repository system. Information may be pulled from multiple systems and combined to provide a corpus that may be examined for indicators of moderate customer dissatisfaction, such as a medium call volume, a plurality of medium priority tickets, upcoming contract renewal, a plurality of mediocre customer experiences, and usage data. A threshold may be used to determine if the customer is a flight risk. If a moderately dissatisfied customer is identified, actions may be proactively taken to lower the risk of the customer closing their account.

### BACKGROUND

The present invention generally relates to telecommunications systems and methods, as well as quality management. More particularly, the present invention pertains to identifying moderate risk accounts.

### SUMMARY

A system and method are presented for determining moderate customer dissatisfaction in an external contact and organization repository system. Information may be pulled from multiple systems and combined to provide a corpus that may be examined for indicators of moderate customer dissatisfaction, such as a medium call volume, a plurality of medium priority tickets, upcoming contract renewal, a plurality of mediocre customer experiences, and usage data. A threshold may be used to determine if the customer is a flight risk. If a moderately dissatisfied customer is identified, actions may be proactively taken to lower the risk of the customer closing their account.

In one embodiment, a method is presented for determining moderate customer dissatisfaction using aggregated dimensions in an external contact and organization repository system, the method comprising the steps of: gathering information automatically from a plurality of systems related to a customer account; examining, by the external contact and organization repository system, the gathered information for the customer account, wherein the gathered information comprises a plurality of dimensions for the account; and determining an aggregate score from each of the plurality of dimensions and comparing the aggregate score to a threshold, wherein if the threshold is reached, performing an action.

In another embodiment, a method is presented for determining moderate customer dissatisfaction using aggregated dimensions in an external contact and organization repository system, the method comprising the steps of: gathering information automatically from a plurality of systems related to a designated customer account; examining, by the external contact and organization repository system, the gathered information for the designated customer account, wherein the gathered information comprises a plurality of dimensions for the account; and presenting to an account manager a summary screen in a GUI of the designated customer account.

### BRIEF DESCRIPTION OF THE DRAWINGS

FIG. 1 is a diagram illustrating an embodiment of an external contact and organization repository system.

FIG. 2 is a flowchart illustrating a process for determining moderately actionable customers in a contact center system.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

External contact and organization repository systems (e.g., Interactive Intelligence Group, Inc.'s PureCloud Relate) surface contact and organization information in contextually relevant ways throughout agent and business user interfaces. These systems can operate as a simple stand-alone customer relationship management (CRM) system or may be synchronized with third-party CRMs such as SalesForce or Microsoft Dynamics, to name a few non-limiting examples. Users of the external contact and organization repository systems may be provided with contextual information about customers, partners, vendors, etc. These users might be present in a business or enterprise environment, or a contact center environments. Many contact center and business users prefer their agents to use a single application for contact center work. Without contact and organization information natively integrated into a unified communication collaborations system (e.g., Interactive Intelligence Group, Inc.'s PureCloud platform), agents are forced to switch between applications or the contact centers need to embed communication controls into those applications. The external contact and organization repository system enables the user interface of the unified communication collaborations system to be the single user interface contact centers need to provide customer service.

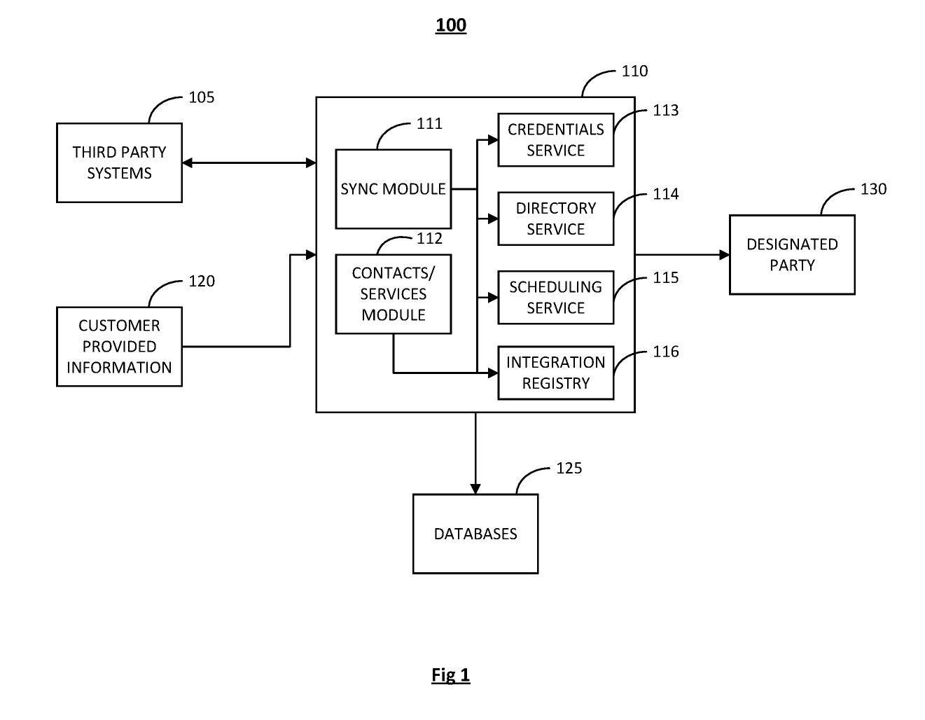

FIG. 1 is a diagram illustrating an embodiment of an external contact and organization repository system, indicated generally at 100. The system 100 might comprise third-party systems 105; an external contact and organization repository system 110 which further comprises: a synchronization module 111, a contacts/services module 112, a credentials service 113, a directory service 114, a scheduling service 115, and an integration registry 116; customer provided information 120, internal databases 125, and a designated party for receiving results 130.

The third-party systems 105 comprise CRMs such as SalesForce or Microsoft Dynamics, to name a couple of non-limiting examples. The third-party systems 105 provide information to the external contact and organization repository system 110 through periodic synchronization jobs utilizing bridging plugins. The CRMs further comprise information used by the external contact and organization repository system 110, such as customer information, partner information, vendor information, etc., external to the organization that need to be tracked. Other systems may also comprise ticketing systems, billing systems, social media accounts, or contact center software. These systems are all capable of providing information to the external contact and organization repository system 110.

The external contact and organization repository system 110 comprises a synchronization module 111, a contacts/services module 112, a credentials service 113, a directory service 114, a scheduling service 115, and an integration registry 116. The synchronization module 111 is responsible for synchronizing the external contact and organization repository system with the third-party systems 105 with regards to contacts, external organizations, relationships and notes based on the information from the third-party systems 105. The contacts/service module 112 may serve as a primary data store and system of record for the contacts, external organizations, relationships and notes. The credentials service 113, directory service 114, scheduling service 115, and the directory 116 are capable of providing information to the synchronization module 111. The synchronization module 111 may also update other systems with information from the external contact and organization repository system 110. The credentials service 113 is capable of securely maintaining customer credentials for third-party systems. The directory service 114 is capable of performing user lookups by email address and verify an organization exists. The directory service 114 may also provide information to the contacts/services module 112. The scheduling service 115 is capable of scheduling recurring synchronization jobs. The integration registry 116 is capable of configuring the synchronization module integrations as well as enabling/disabling the integrations.

The external contact and organization repository system 110 may also store gathered information from the third-party systems 105 and customer provided information 120 into internal databases 125.

The customer provided information 120 may be manually provided by a customer which provides data containing contacts and external organizations to the external contact and organization repository system 110 in addition to the third-party systems 105.

The designated party 130 comprises an agent or other party of the contact center who is designated to receive the information related to a customer or multiple customer accounts. The designated party views information presented by the external contact and organization repository system 110 through a GUI. In an embodiment, the designated party 130 is also a user of the external contact and organization repository system in the business, enterprise, or contact center environment.

In an embodiment, a feature of the external contact and organization repository system 100 is to pull information together from multiple systems (e.g., contact center software, CRMs, ticketing systems, billing systems, and social media accounts, to name a few non-limiting examples) and combine this information into useful ways. Traditionally, only high flight risk customers (those who are in immediate danger of leaving the company) can be identified based on a limited number of factors (e.g., high number of tickets or complaints, whether the customer is up for contract renewal, a drop of usage, satisfaction numbers, survey scores, etc.). While this information is useful, the ability to automatically recognize moderate flight risk customers would allow a contact center to proactively identify customers who have a plurality of moderately negative experiences that makes them a danger of leaving. Factors taken alone may not alarm the system, but when viewed together, these factors would trigger alarm.

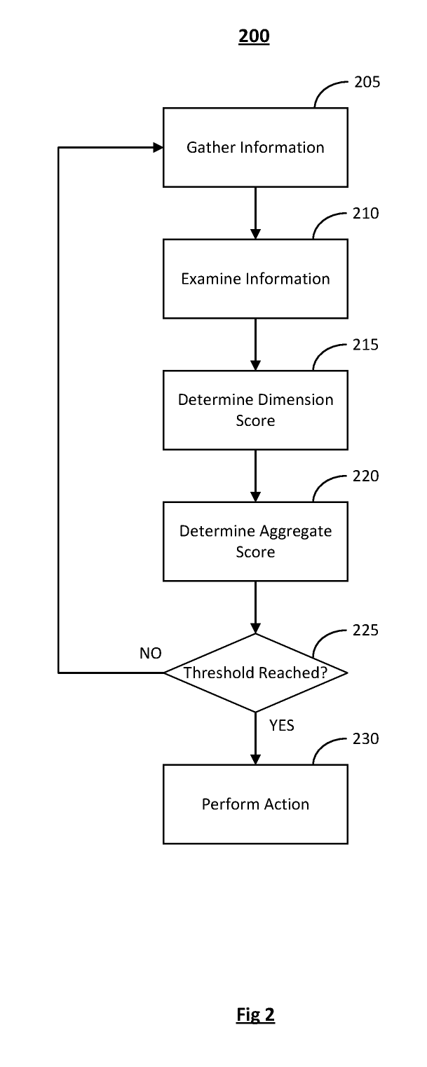

FIG. 2 is a flowchart illustrating a process for determining moderately actionable customers or customer accounts in a contact center system, indicated generally at 200. The process 200 occurs in the external contact and organization repository system 100 (FIG. 1).

In operation 205, information is gathered related to a customer account. For example, the information may be gathered from a plurality of systems, such as the contact center software, CRM software, ticketing systems, billing systems, social media accounts, usage data systems, and diagnostic data systems, to name a few non-limiting examples. The systems may be internally and/or externally connected to the external contact and organization repository system. In an embodiment, the gathering of information may be performed by the external contact and organization repository system. The synchronization module may synchronize information within the external contact and organization repository system with the third-party systems. Information may also be pulled from the contacts/service module as well as the internal databases. In another embodiment, the gathering of information may be performed by one or more third-party systems which relay the gathered information to the external contact and organization repository system. In another embodiment, both the external contact and organization repository system and the third-party systems contribute to the gathering of information with the third-party systems relaying information to the external contact and organization repository system. The type of information gathered may be specified by a system user or be pre-set in the system. Control is passed to operation 210 and the process 200 continues.

In operation 210, the gathered information is examined. For example, the external contact and organization repository system may examine the gathered information related to the customer account. The gathered information might comprise a plurality of dimensions for the account. Dimensions might comprise: a medium call volume, a plurality of medium priority tickets, upcoming contract renewal, a plurality of mediocre customer experiences, and usage data. In an embodiment, the gathered information is examined for the specified dimensions. For example, the call volume for a customer account may indicate that the customer is having to call into the contact center more often than usual, but not at a high enough volume to trigger alarm. Having a higher than normal amount of medium priority tickets might indicate growing customer frustration or dissatisfaction relating to their account with the contact center. Whether the customer's contract is coming up for renewal might also indicate the potential of a customer wanting to not renew. Having a plurality of mediocre customer experiences may also be indicative of growing customer dissatisfaction. Usage data might also indicate that the customer usage has declined which could be an indicator of dissatisfaction with the system. Control is passed operation 215 and the process 200 continues.

In operation 215, a dimension score is determined. The dimension score(s) may be determined by the external contact and organization repository system. For example, a score of each dimension is determined by the system. The score might be based on pre-defined criteria. For example, different weights may be given to different dimensions based on user preference. The different weights may be designed to trigger a threshold sooner or later. In an embodiment, the dimension score may be based on a plurality of events, for example, within the dimension such as a plurality of medium priority tickets each being assigned a score based on the level of priority that determines that dimension score for priority ticketing. Control is passed to operation 220 and the process 200 continues.

In operation 220, an aggregate score is determined. For example, an aggregate score is determined comprising each of the dimension scores previously determined in operation 215. The aggregate score may be determined by the external contact and organization repository system. Control is passed to operation 225 and the process 200 continues.

In operation 225, it is determined whether the aggregate score meets a threshold. If it is determined that the aggregate score meets a threshold, control is passed to operation 230 and the process 200 continues. If it is determined that the aggregate score does not meet a threshold, control is passed back to operation 205 and the process 200 continues.

The determination in operation 225 may be based on any suitable criteria. For example, a threshold may be pre-determined by a user or automatically set. If the threshold is reached, the external contact and organization repository system may conclude that the customer account may be a moderate flight risk. If the threshold is not reached, the system may not take any action at this point and continue to watch the customer account.

In operation 230, an action is performed. For example, an action may comprise the external contact and organization repository system notifying an agent, a supervisor, an account manager, or other designated party, of growing customer dissatisfaction. In an embodiment, a listing of customer accounts may be provided to a designated party comprising the identified moderately dissatisfied customer accounts. In another embodiment, the information may be presented to a designated party on a summary screen in a GUI for the designated customer account. The summary screen might comprise indicators (such as a gauge or a percentage) of the satisfaction or dissatisfaction level for that account. The indicators might also provide information regarding how like the customer is to leave.

In an embodiment, the process 200 may be repeated for a plurality of customer accounts or, the process may end if only one account is examined. In another embodiment, an agent might be able to obtain insight as to why the customer is a potential flight risk before interacting with the customer. This allows an agent to take remedial steps to improve the customer experience or address any problems the customer might have.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for determining moderate customer dissatisfaction using aggregated dimensions in an external contact and organization repository system, the method comprising the steps of:
a. gathering information automatically from a plurality of systems related to a customer account;
b. examining, by the external contact and organization repository system, the gathered information for the customer account, wherein the gathered information comprises a plurality of dimensions for the account; and
c. determining an aggregate score from each of the plurality of dimensions and comparing the aggregate score to a threshold, wherein if the threshold is reached, performing an action.

2. The method of claim 1, wherein the moderate customer dissatisfaction further comprises a customer flight risk.

3. The method of claim 1, wherein the step of gathering information is performed by the external contact and organization repository system.

4. The method of claim 1, wherein the step of gathering information is performed by one or more third-party systems, wherein the one or more third-party systems convey gathered information to the external contact and organization repository system.

5. The method of claim 1, wherein the step of gathering information is performed by a combination of the external contact and organization repository system and one or more third-party systems, wherein the one or more third-party systems convey gathered information to the external contact and organization repository system.

6. The plurality of systems of claim 1, wherein the plurality of systems are internally connected to the external contact and organization repository system.

7. The plurality of systems of claim 1, wherein the plurality of systems are externally connected to the external contact and organization repository system.

8. The plurality of systems of claim 1, wherein the plurality of systems are a combination of internally and externally connected to the external contact and organization repository system.

9. The method of claim 1, wherein the plurality of systems comprise at least one of: contact center software, customer relationship management software, a ticketing system, a billing system, a social media account, a usage data system, and a diagnostic data system.

10. The method of claim 1, wherein the plurality of dimensions comprise one or more of: medium call volume, a plurality of medium priority tickets, upcoming contract renewal, a plurality of mediocre customer experiences, and usage data.

11. The method of claim 1, wherein an action comprises notifying a designated party of customer dissatisfaction.

12. The designated party of claim 11, wherein the designated party comprises one or more of: a contact center agent, a contact center supervisor, and an account manager.

13. The method of claim 1, wherein the process is repeated for a plurality of customer accounts.

14. The method of claim 11, wherein an action comprises presenting a listing of customer accounts comprising dissatisfied customers to a designated party.

15. The designated party of claim 14, wherein the designated party comprises one or more of: a contact center agent, a contact center supervisor, and an account manager.

16. The method of claim 1, wherein if the threshold is not reached, repeating the process from step (a) until the threshold is reached.

17. A method for determining moderate customer dissatisfaction using aggregated dimensions in an external contact and organization repository system, the method comprising the steps of:
a. gathering information automatically from a plurality of systems related to a designated customer account;
b. examining, by the external contact and organization repository system, the gathered information for the designated customer account, wherein the gathered information comprises a plurality of dimensions for the account; and
c. presenting to an account manager a summary screen in a GUI of the designated customer account.

18. The method of claim 17, wherein the moderate customer dissatisfaction further comprises a customer flight risk.

19. The method of claim 17, wherein the step of gathering information is performed by the external contact and organization repository system.

20. The method of claim 17, wherein the step of gathering information is performed by one or more third-party systems, wherein the one or more third-party systems convey gathered information to the external contact and organization repository system.

21. The method of claim 17, wherein the step of gathering information is performed by a combination of the external contact and organization repository system and one or more third-party systems, wherein the one or more third-party systems convey gathered information to the external contact and organization repository system.

22. The plurality of systems of claim 17, wherein the plurality of systems are internally connected to the external contact and organization repository system.

23. The plurality of systems of claim 17, wherein the plurality of systems are externally connected to the external contact and organization repository system.

24. The plurality of systems of claim 17, wherein the plurality of systems are a combination of internally and externally connected to the external contact and organization repository system.

25. The method of claim 17, wherein the plurality of systems comprise at least one of: contact center software, customer relationship management software, a ticketing system, a billing system, a social media account, a usage data system, and a diagnostic data system.

26. The method of claim 17, wherein the plurality of dimensions comprise one or more of: medium call volume, a plurality of medium priority tickets, upcoming contract renewal, a plurality of mediocre customer experience, and usage data.

27. The method of claim 17, wherein the account manager is engaged in contact with a party to the designated customer account.

28. The method of claim 17, wherein the summary screen comprises indicators of flight risk for the designated customer account.

29. The method of claim 28, wherein indicators comprise at least one of: a gauge and a percentage.
